(19) United States
(12) Patent Application Publication
(10) Pub. No.: US 2015/0176636 A1
(43) Pub. Date: Jun. 25, 2015

(54) Screw-Locking Washer

(71) Applicant: PEM MANAGEMENT, INC., Wilmington, DE (US)

(72) Inventor: Trevor Fahy, Galway (IE)

(21) Appl. No.: 14/554,941

(22) Filed: Nov. 26, 2014

Related U.S. Application Data
(60) Provisional application No. 61/909,657, filed on Nov. 27, 2013.

(51) Int. Cl. F16B 43/00

(52) U.S. Cl. CPC F16B 43/00

(57) ABSTRACT

A locking washer is preferably assembled to the top of an internally threaded bushing and retained on the bushing by force fit into a groove on the bushing or by adhesion. The washer includes a peripheral collar and an integral tang which diametrically extends into a central opening of the collar. When a screw is inserted into the threads of the bushing the tang becomes bent over and thereafter when the screw has been further advanced the tang longitudinally extends between the threads of the screw and the bushing. More than one washer may be used.

### RELATED APPLICATION

This patent application is a non-provisional of U.S. provisional patent application No. 61/909,657 entitled “Screw-Locking Device” filed on Nov. 27, 2013, from which priority is hereby claimed.

### FIELD OF THE INVENTION

This invention relates to threaded female bushings having means for providing a prevailing torque to an inserted screw. More specifically it related to such bushings in which the screw is received sub-flush within the bushing and where electrical contact between the screw and the bushing is required.

### BACKGROUND OF THE INVENTION

There are instances within the field of electronics where screw assemblies are used that require reliable electrical contact between the screw and a receiving threaded female bushing. An example is a tuning screw employed as part of the electrical circuitry in a wireless phone substation radio assembly. These screws must be headless and adjusted up and down many times, each time remaining locked in place. Presently this locking function is achieved by a secondary operation such as gluing, or employing either a lock nut or a spring loaded element to apply a prevailing torque to the screw.

These solutions however are problematic for several reasons. Gluing requires a secondary operation which can be messy. The glue requires a curing time which slows production and the results are often inconsistent. In addition, adjustability and service disassembly is restricted.

The use of a lock nut is also less than desirable because like gluing it requires a secondary operation. A lock nut cannot be used for sub-flush screws and tightening the screw down against the lock nut can inadvertently change the desired position of the screw which must be precisely located.

The use of a traditional nylon locking nut has severe limitations in the electronic tuning screw environment. In a traditional locking bushing a nylon locking washer is located at the top of the nut or bushing to apply a prevailing torque to the screw through frictional engagement with the screw. During engagement the nylon material elastically and plastically deforms into the thread form of the screw. This is unacceptable for electronic tuning screws as there must be metal-to-metal contact between the screw and the bushing to eliminate undesirable electrical capacitive effects. In addition, the applied prevailing torque must be available throughout the full travel of the screw in the bushing.

Another solution that has been tried is the use of axially sprung screws that use thread tension to provide a frictional locking effect however these parts are very difficult to manufacture, are expensive and the number of possible re-use cycles is limited.

There is therefore a need in the art for an electronic tuning screw assembly which solves these problems.

### SUMMARY OF THE INVENTION

The present invention has been devised to meet the need in the art for a better tuning screw assembly which provides prevailing torque locking on screws that run sub-flush and also require electrical contact between the screw and the bushing. In one embodiment of the invention a solution is provided that employs a punched nylon washer in the form of a disc fitted to the top of the bushing. The disc has an inward extending tang which as the screw is applied to the bushing is pushed vertically downward into the bushing against the threads along one side. This results in a vertical strip of nylon lying against the threads inside the bushing that provides a prevailing torque.

This inventive solution provides the desired performance requirements: it allows metal-to-metal contact between the male and female threads for a large portion of the internal bushing diameter; it provides consistent thread prevailing torque at any height within the bushing; and it provides a locking function that any standard thread screw can use and be changed in service.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top front isometric view of the invention as assembled;

FIG. 2 is an exploded isometric view of the assembly of FIG. 1; and,

FIG. 3 is a partial cutaway elevation view taken from FIG. 1 as shown in the figure.

### DETAILED DESCRIPTION OF THE INVENTION

Referring now to FIG. 1 the locking washer 15 of the invention is shown in its assembled condition being installed at the top of bushing 11. The washer can be retained in the top of the bushing by any suitable means including force-fit, adhesion or captured by peening over the top edges of the bushing. Multiple washers can be used. An exemplary suitable material is nylon.

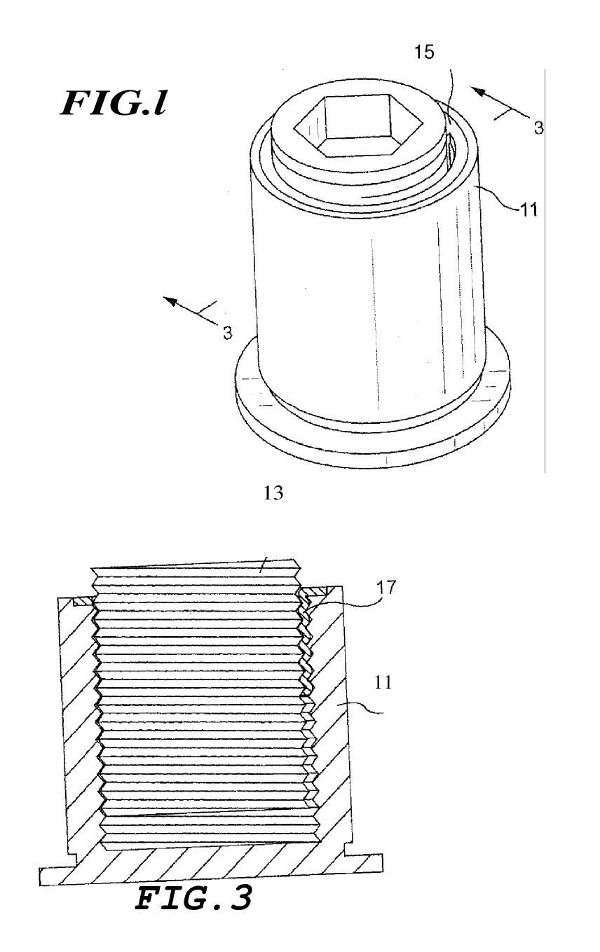

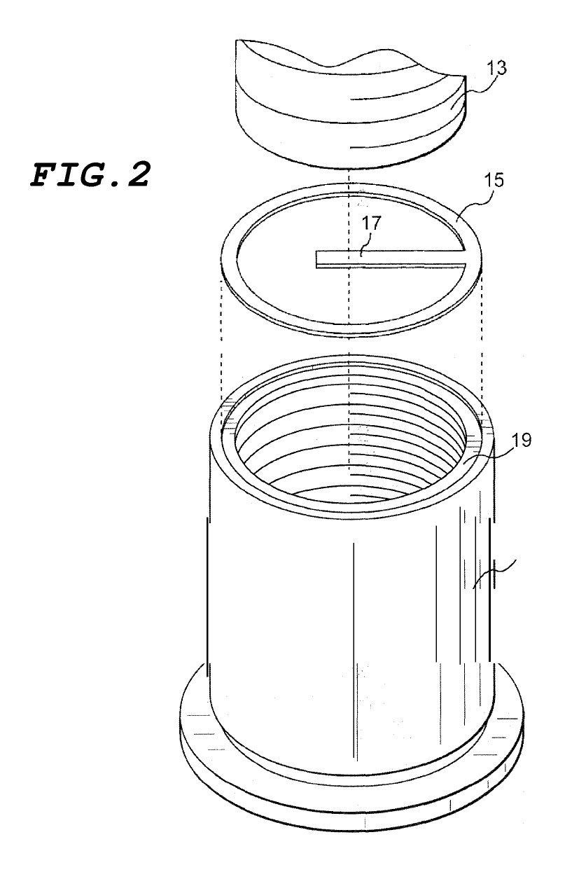

As shown in FIG. 2 each washer applied to the bushing includes an inward facing tang 17. The washer of this embodiment is seen being received in a groove 19 around the top of the internally threaded bushing 11. As further depicted in FIG. 3, when screw 13 is inserted into the threads of the bushing, tang 17 becomes bent over and thereafter lies longitudinally along the inner wall of the bushing between the threads of the screw and the threads of the bushing. This interference fit of the tang between the threads provides the desired prevailing torque and also forces the screw thread against the wall of the bushing to ensure good electrical contact.

The washers of the invention can be preformed and assembled to the bushing by manual or automatic feeding using a vibratory bowl. By another method the washer material can be provided as a continuous feed strip and punched into the desired shape and put into place using the diameter of the nut body itself.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A screw-locking device, comprising:
a circular washer comprising a peripheral collar and a central opening; and
a tang integral with said collar and diametrically extending into the central opening, said tang being sufficiently deformable to bend at its junction with the collar without distorting the collar.

2. The device of claim 1 further including a bushing having a top to which one or more of said washers is applied.

3. The device of claim 2 wherein said washer is located within a groove around the top of the washer.

4. The device of claim 2 wherein said washer is adapted such that when a screw is inserted into the threads of the bushing the tang becomes bent over and after the screw has further advanced the tang lies longitudinally along an inner wall of the bushing between the threads of the bushing and the screw.

5. The device of claim 2 wherein the washer is retained in the top of the bushing by force fit or or adhesion.

6. The device of claim 1 wherein said washer is composed of Nylon.
